(19) United States
(12) Patent Application Publication
(10) Pub. No.: US 2025/0334831 A1
(43) Pub. Date: Oct. 30, 2025

(54) DISPLAY APPARATUS

(71) Applicant: SAMSUNG ELECRONICS CO., LTD., Suwon-si (KR)

(72) Inventors: Soonjung KIM, Suwon-si (KR); Byungsun Moon, Suwon-si (KR); Dahoon Won, Suwon-si (KR); Dongjung Yun, Suwon-si (KR)

(73) Assignee: SAMSUNG ELECTRONICS CO., LTD., Suwon-si (KR)

(21) Appl. No.: 19/263,001

(22) Filed: Jul. 8, 2025

Related U.S. Application Data
(63) Continuation of application No. PCT/KR2023/019769, filed on Dec. 4, 2023.

(30) Foreign Application Priority Data
Jan. 20, 2023 (KR) 10-2023-0008912

(51) Int. Cl. G02F 1/1333; F21V 8/00; G02F 1/13357

(52) U.S. Cl. CPC G02F 1/133317; G02B 6/0088; G02F 1/133314; G02F 1/133615; G02F 2201/465

(57) ABSTRACT

There is provided a display apparatus including a display panel, a backlight unit to supply light to the display and including a plurality of optical sheets, a bottom chassis behind the backlight unit, and a middle mold on the bottom chassis, and the middle mold includes a sheet holder on one edge of the middle mold, the sheet holder includes an opening through which the plurality of optical sheets are inserted in one direction, and a fixing portion protruding from the sheet holder to fix the plurality of optical sheets, and the fixing portion is inclined in one direction toward an end thereof.

### CROSS-REFERENCE TO RELATED APPLICATIONS

This application is a continuation of International Application No. PCT/KR2023/019769, filed on Dec. 4, 2023, which is based on and claims priority to Korean Patent Application No. 10-2023-0008912, filed on Jan. 20, 2023, in the Korean Intellectual Property Office, the disclosures of which are incorporated by reference herein in their entireties.

### BACKGROUND

### 1. Field

The disclosure relates to a display apparatus, and more particularly, to a display apparatus having a structure for fixing an optical sheet.

### 2. Description of Related Art

A display apparatus is a type of output device that converts acquired or stored electrical information into visual information and displays such information to a user, and is used in various fields such as homes and workplaces.

A display apparatus is typically an appliance that displays a screen, and includes a monitor and a television. The display apparatus uses self-emissive display panels, such as an organic light-emitting diode (OLED) and non-emissive display panels, such as a liquid crystal display (LCD) panel.

A display device including a non-emissive display panel includes a backlight for supplying light to the display panel. In addition, such a display device includes optical sheets disposed between the display panel and the backlight to modify the characteristics of the light supplied from the backlight.

The optical sheets include a diffusion sheet for diffusing light, and a prism sheet and a polarizing sheet for directing light to the display panel at a certain angle.

### SUMMARY

Provided a display apparatus that may improve display quality.

Further, provided is a display apparatus including an optical sheet that may be easy to manufacture.

Further, provided is a display apparatus including an optical sheet that may prevent glare.

Further, provided is a display apparatus including an optical sheet without sheet holding grooves.

Technical aspects to be achieved in this document are not limited to those mentioned above, and other technical aspects not mentioned will be clearly understood by those skilled in the art from the description below.

According to an aspect of the disclosure, a display apparatus includes: a display panel; a backlight unit configured to supply light to the display panel and including a plurality of optical sheets; a bottom chassis behind the backlight unit; and a middle mold on the bottom chassis; and the middle mold includes: a sheet holder on one edge of the middle mold, the sheet holder including an opening through which the plurality of optical sheets are inserted in one direction, and a fixing portion protruded from the sheet holder and configured to fix the plurality of optical sheets, the fixing portion being at least partly inclined in the one direction.

The fixing portion may be extended along a longitudinal direction of the sheet holder.

The fixing portion may include a plurality of fixing members that are spaced apart along a longitudinal direction of the sheet holder.

The fixing portion may include a first fixing portion, and the middle mold may further include a second fixing portion protruded at a position spaced apart from the first fixing portion along another direction, the second fixing portion having a shorter protruded length than the first fixing portion.

The second fixing portion has a degree of inclination that is greater than a degree of inclination of the first fixing portion.

The sheet holder may include an outer edge facing the opening, a front formation surface extended from the outer edge, and a rear formation surface, extended from the outer edge and facing the front formation surface, and an outer edge, the front formation surface, and the rear formation surface define an insertion space into which the plurality of optical sheets are inserted through the opening.

The fixing portion may be arranged on at least one of the front formation surface and the rear formation surface.

The fixing portion may include a first front fixing portion, protruded from the front formation surface, and a first rear fixing portion protruded from the rear formation surface, and the first front fixing portion and the first rear fixing portion may be at positions corresponding to each other.

The fixing portion further may include a second front fixing portion, protruded at a position spaced apart along another direction, the second front fixing portion including a protruding length that is less than a protruding length of the first front fixing portion.

The rear fixing portion may include a first rear fixing portion, and the fixing portion further may include a second rear fixing portion protruded at a position spaced apart along another direction, the second rear fixing portion including a shorter protruded length than the first rear fixing portion.

The second front fixing portion may have a degree of inclination that is greater than a degree of inclination of the first front fixing portion.

The second rear fixing portion may have a degree of inclination that is greater than a degree of inclination of than the first rear fixing portion.

The plurality of optical sheets may include a first optical sheet and a second optical sheet, and a thickness of the first optical sheet may be different than a thickness of the second optical sheet.

The sheet holder may be on an upper edge of the middle mold.

### BRIEF DESCRIPTION OF THE DRAWINGS

The above and other aspects, features, and advantages of specific embodiments of the present disclosure will be more apparent from the following description with reference to the accompanying drawings, in which:

FIG. 1 is a perspective view illustrating a display apparatus according to one or more embodiments;

FIG. 2 is an exploded perspective view illustrating some configurations of the display apparatus of FIG. 1;

FIG. 3 is a cross-sectional view illustrating a part of a cross-section of the display apparatus of FIG. 1 taken along a front-to-back direction;

FIG. 4 is an exploded perspective view illustrating a plurality of optical sheets and a sheet holder arranged on a middle mold;

FIGS. 5A and 5B are views illustrating a structure of a sheet holder according to one or more embodiments;

FIGS. 6A and 6B are side views illustrating a process of coupling a plurality of optical sheets to the sheet holder of FIGS. 5A and 5B;

FIGS. 7A and 7B are views illustrating a state in which the plurality of optical sheets are coupled to the sheet holder according to one or more embodiments.

FIG. 8 is a view illustrating a structure of a sheet holder according to one or more embodiments.

FIGS. 9A and 9B are side views illustrating a process in which the plurality of optical sheets are fixed to the sheet holder of FIG. 8.

FIG. 10 is a view illustrating a state in which the fixing portion configured with a plurality of fixing members is provided on both the front and rear formation surfaces of a sheet holder, according to one or more embodiments; and

FIGS. 11A and 11B are views illustrating a state in which the fixing portion configured with the plurality of fixing members is provided on the front or rear formation surface of a sheet holder, according to one or more embodiments.

### DETAILED DESCRIPTION

Various embodiments of the disclosure and terms used herein are not intended to limit the technical features described herein to specific embodiments, and should be understood to include various modifications, equivalents, or substitutions of the corresponding embodiments.

In describing of the drawings, similar reference numerals may be used for similar or related elements.

The singular form of a noun corresponding to an item may include one or more of the items unless clearly indicated otherwise in a related context.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases. For example, the expression, “at least one of A and B,” should be understood as including only A, only B, or both A and B.

As used herein, the term “and/or” includes any and all combinations of one or more of the associated listed items.

Terms such as “1st”, “2nd”, “primary”, or “secondary” may be used simply to distinguish an element from other elements, without limiting the element in other aspects (e.g., importance or order).

When an element (e.g., a first element) is referred to as being “(functionally or communicatively) coupled” or “connected” to another element (e.g., a second element), the first element may be connected to the second element, directly (e.g., wired), wirelessly, or through a third element.

It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

Also, the terms used herein are used to describe the embodiments and are not intended to limit and/or restrict the disclosure. The singular forms “a,” “an” and “the” are intended to include the plural forms as well, unless the context clearly indicates otherwise. In this disclosure, the terms “including”, “having”, and the like are used to specify features, figures, steps, operations, elements, configurations, or combinations thereof, but do not preclude the presence or addition of one or more of the features, figures, steps, operations, elements, configurations, or combinations thereof.

It will be understood that, although the terms first, second, primary, secondary, etc., may be used herein to describe various elements, but elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

Further, as used in the disclosure, the terms “front”, “rear”, “top”, “bottom”, “side”, “left”, “right”, “upper”, “lower”, and the like are defined with reference to the drawings, and are not intended to limit the shape and position of each configuration.

Various embodiments of the present disclosure will be described in detail below with reference to the accompanying drawings.

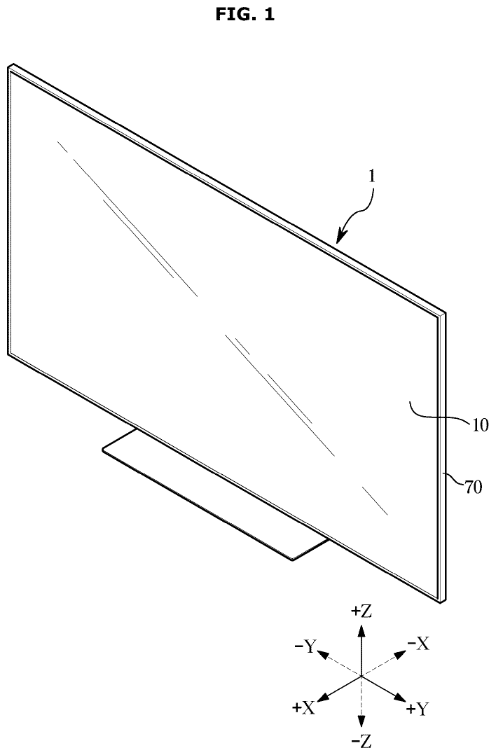

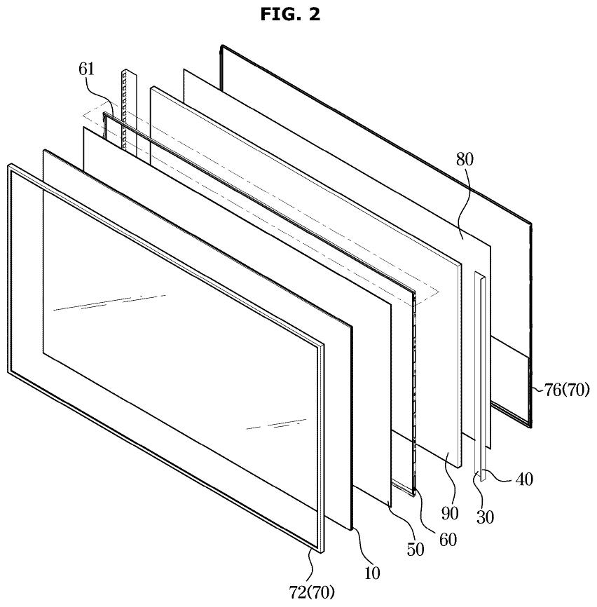

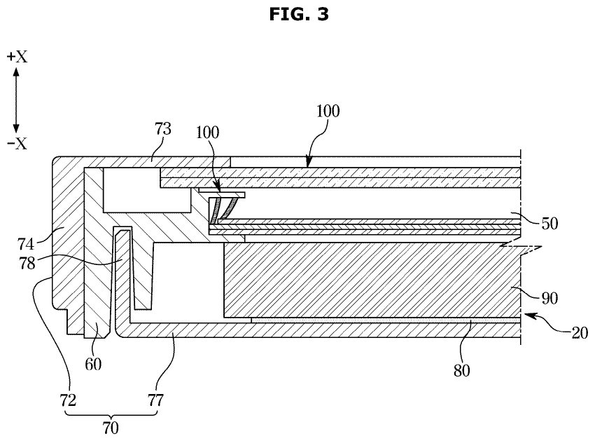

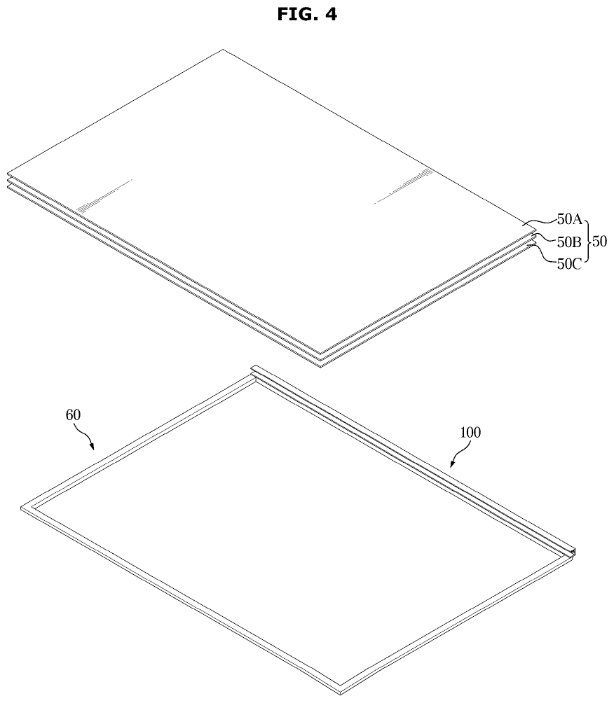

FIG. 1 is a perspective view illustrating a display apparatus according to one or more embodiments. FIG. 2 is an exploded perspective view illustrating some configurations of the display apparatus of FIG. 1. FIG. 3 is a cross-sectional view illustrating a part of a cross-section of the display apparatus of FIG. 1 taken along a front-to-back direction. FIG. 4 is an exploded perspective view illustrating a plurality of optical sheets and a sheet holder arranged on a middle mold.

Referring to FIG. 1, a display apparatus 1 according to one or more embodiments may be a self-emissive display apparatus in which a light-emitting element (LED) is disposed for each pixel, allowing each pixel to emit light by itself. However, the present disclosure is not limited thereto, and the display apparatus 1 may be a non-emissive display apparatus, such as a liquid crystal display (LCD), that emits light using external light. In the present disclosure, for convenience, a non-emissive display apparatus based on an LCD will be described.

Although the description of the present disclosure describes a flat display apparatus 1 as an example, it should be understood by those skilled in the art that the display apparatus 1 may be implemented not only as a flat display apparatus but also as a curved display apparatus having a screen with a fixed curvature, a variable curvature display apparatus capable of changing the curvature of the screen, and the like, and is not limited thereto.

On the other hand, the three-dimensional coordinate system of the XYZ axes shown in FIG. 1 is based on the display apparatus 1, wherein the plane in which a screen of the display apparatus 1 is located may be the YZ plane, and the direction in which the image is output may be the +X direction.

The display apparatus 1 may typically be used in an upright state, and a user watches the image from the front of the display apparatus 1. Therefore, the +X direction, in which the image is output, may be referred to as the front, and the opposite direction,−X, may be referred to as the rear. In addition, the +Y direction may be referred to as the left side, the −Y direction may be referred to as the right side, the +Z direction may be referred to as the upper side, and the −Z direction as the lower side.

Since the coordinate system shown is based on the display apparatus 1, the same coordinate system may be applied regardless of whether the display apparatus 1 is lying down or standing upright.

Referring to FIGS. 1, 2, 3, and 4, the display apparatus 1 may include a display module therein that displays an image. The display module may include a display panel 10 on which the image is displayed, and a backlight unit (BLU) 20 that provides light to the display panel 10.

The BLU 20 may be configured to transmit light to the display panel 10 in a planar direction. The BLU 20 may include a printed circuit board, a light source module 40, a light guide plate 90, and a plurality of optical sheets 50. In other words, the BLU 20 may include the light source module 40 disposed on a rear side of the display panel 10, the light guide plate 90 disposed in a space between the display panel 10 and the light source module 40 so that the light supplied from the light source module 40 is diffused and transmitted to the display panel 10 located at a front side, and the plurality of optical sheets 50 disposed between the display panel 10 and the light source module 40 to change the optical properties.

The display apparatus 1 may include a middle mold 60 that supports the display panel 10 and a display chassis 70 that forms the exterior. The display chassis 70 may include a top chassis 72 coupled to a front side of the middle mold 60 to hold a state in which the display panel 10 is installed on the middle mold 60, and a bottom chassis 76 coupled to a rear side of the middle mold 60, with the light source module 40 described above disposed on both inner sides thereof. The light source module 40 may be disposed on a front side of the bottom chassis 76 to emit light toward the display panel 10. The light source module 40 may include a light-emitting element (LED) that emits blue light. The blue light may be converted to at least one of red light, green light, and blue light. Although an edge-type display method is described in one or more embodiments of the present disclosure, it is not limited thereto and may also be applied to a direct-type display method.

The middle mold 60 may include the display panel 10 and the top chassis 72 sequentially installed on a front side thereof, and the bottom chassis 76 installed on a rear side, thereby not only supporting each configuration but also maintaining a state in which the display panel 10 and the bottom chassis 76 are spaced apart from each other.

The top chassis 72 may include a bezel portion 73 that covers a front outer side of the display panel 10, and a top side portion 74 that is bent rearward from an end of the bezel portion 73 and covers a side of the middle mold 60.

The bottom chassis 76 may include a rear surface portion 77 that forms a rear surface of the display module, and a bottom side portion 78 that extends forwardly from a perimeter of the rear surface portion 77 and is coupled within the middle mold 60. The bottom chassis 76 may be formed in a polygonal plate shape having high strength and may include a metallic material (e.g., aluminum or aluminum alloy, etc.) with low thermal deformation due to heat generated by the heat of the accommodated light source module 40 and/or the display panel 10. The bottom chassis 76 may be formed by molding a plastic material, such as polycarbonate (PC), or by adding glass fibers to the plastic material.

The plurality of light source modules 40 may be mounted on the printed circuit board. The size of the printed circuit board may correspond to the length of the display panel 10 in an up-and-down direction. In one or more embodiments, the plurality of light source modules 40 may be arranged corresponding to the height of the display apparatus in the up-and-down direction, but the arrangement of the plurality of light source modules 40 is not limited.

The reflective sheet 80 may reflect light emitted from the light source module 40 toward the display panel 10, or re-reflect light reflected back by the optical sheet 50 or the display panel 10 toward the display panel 10. The reflective sheet 80 may be disposed on a front side of the printed circuit board and improve the light efficiency by reflecting the leakage light toward the display panel 10. The reflective sheet 80 may be disposed between the light guide plate 90 and the bottom chassis 76. The reflective sheet 80 may be coated with a highly reflective coating agent (e.g., silver, TiO2) of white or silver color. The reflective sheet 80 may include a reflective plate.

The plurality of optical sheets 50 may cause the light emitted from the light source module 40 and directed toward the display panel 10 to have a uniform luminance. The light of uniform luminance that has passed through the plurality of optical sheets 50 may be incident on the display panel 10. The plurality of optical sheets 50 may include a protective sheet, a prism sheet, or a diffuser sheet. As such, the plurality of optical sheets 50 may include different sheets, each of which may have a different thickness.

The optical sheet may include at least one sheet. Further, in addition to the optical sheets described above, various other types of optical sheets may be used to improve the optical properties of light.

The display panel 10 may display an image by converting electrical signals into optical signals. The display panel 10 may include a liquid crystal panel 11 and polarizing plates, polarizing plate 12 and polarizing plate 13.

The liquid crystal panel 11 may be disposed on a front surface of the BLU 20 to block or transmit light emitted from the BLU 20 to form an image. The front surface of the liquid crystal panel 11 may form the screen of the display apparatus 1 described above, and may be configured with a plurality of pixels. The plurality of pixels included in the liquid crystal panel 11 may each independently block or transmit light from the BLU 20, and the light transmitted by the plurality of pixels may form an image displayed on the display apparatus 1.

The liquid crystal panel 11 may include first and second transparent substrates and a liquid crystal layer. In addition, the liquid crystal panel 11 may include a pixel electrode, a thin film transistor, a common electrode, and a color filter. The first and second transparent substrates may form the exterior of the liquid crystal panel 11 and may protect the liquid crystal layer and color filters disposed therebetween. The first and second transparent substrates may be configured as tempered glass or transparent resin.

Liquid crystals may represent an intermediate state between a solid (crystal) and a liquid. In general, when heat is applied to a solid state material, a state change occurs from a solid state to a transparent liquid state at the melting temperature. In contrast, when heat is applied to a solid-state liquid crystal material, such a material changes to an opaque and cloudy liquid at the melting temperature and then changes to a clear liquid state. Most of these liquid crystal materials are organic compounds, and their molecular shape is a long and thin rod shape, and the arrangement of the molecules may be irregular in some directions, but regular crystalline form in other directions. As a result, liquid crystals may have both the fluidity of a liquid and the optical anisotropy of a crystal (solid).

In addition, liquid crystals may exhibit optical properties in response to changes in the electric field. For example, liquid crystals may change the orientation of the arrangement of the molecules constituting the liquid crystals in response to changes in the electric field. When an electric field is generated in the liquid crystal layer, the liquid crystal molecules in the liquid crystal layer may be arranged according to the direction of the electric field, and when no electric field is generated in the liquid crystal layer, the liquid crystal molecules may be arranged irregularly or along an alignment film.

As a result, the optical properties of the liquid crystal layer may vary depending on the presence or absence of an electric field passing through the liquid crystal layer. For example, if no electric field is formed in the liquid crystal layer, the arrangement of the liquid crystal molecules in the liquid crystal layer may cause light polarized by the first polarizing film to pass through the liquid crystal layer and then pass through the second polarizing film. On the other hand, when an electric field is formed in the liquid crystal layer, the arrangement of the liquid crystal molecules in the liquid crystal layer may change, preventing the light polarized by the first polarizing film from passing through the second polarizing film.

The middle mold 60 may include a sheet holder 100 configured to hold the plurality of optical sheets 50. The sheet holder 100 may be arranged on one edge of the middle mold 60. In addition, the sheet holder 100 may also be formed on an edge adjacent to the one edge of the middle mold 60. In addition, the sheet holder 100 may also be formed on an edge facing the one edge of the middle mold 60. In a case where the light source module 40 is an edge-type, the sheet holder 100 may be formed on an edge where the light source module 40 is not located.

The sheet holder 100 may be formed on an upper edge 61 of the middle mold 60, based on when the display panel 10 of the display apparatus 1 is facing forward. To prevent the plurality of optical sheets 50 from falling or moving by gravity, it is effective to fix an upper side of the plurality of optical sheets 50. Thus, it may be formed on the upper edge 61 of the middle mold 60.

In the following, a method of securing the plurality of optical sheets 50 to the sheet holder 100 will be described in detail.

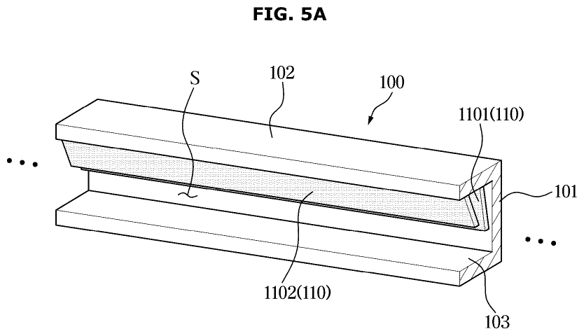

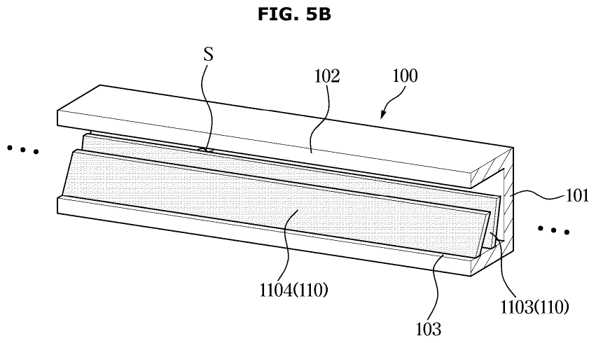

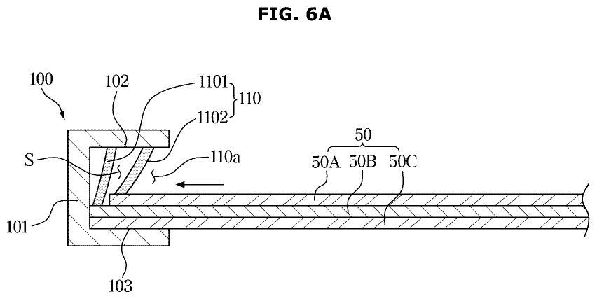

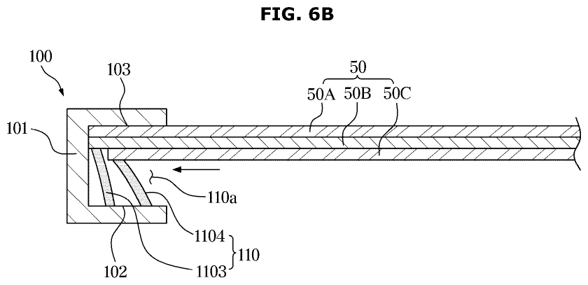

FIGS. 5A and 5B are views illustrating a structure of the sheet holder according to one or more embodiments. FIGS. 6A and 6B are side views illustrating a process of coupling the plurality of optical sheets to the sheet holder of FIGS. 5A and 5B.

Referring to FIGS. 5A, 5B, 6A, and 6B, the middle mold 60 may include the sheet holder 100 on one edge of the middle mold 60. The sheet holder 100 may be configured to extend along the one edge of the middle mold 60. The sheet holder 100 may be formed integrally with the middle mold 60. For example, the middle mold 60 may be injection molded in a form including the sheet holder 100. However, the present disclosure is not limited thereto, and the sheet holder 100 may be attached or coupled to the middle mold 60.

The sheet holder 100 may include an outer edge 101 that forms the other side of the sheet holder 100. The outer edge 101 may be located on an outer side of the position where the plurality of optical sheets 50 secured to the sheet holder 100 are located. When the plurality of optical sheets 50 are inserted into the inner side of the sheet holder 100, they may contact the outer edge 101. However, the plurality of optical sheets 50 may not contact the outer edge 101 to allow for thermal expansion, and it is sufficient to be secured to a fixing portion 110, which will be described later. The outer edge 101 is shown as being planar, but may also be curved.

The sheet holder 100 may include a front formation surface 102 and a rear formation surface 103 extending from the outer edge 101 to face each other. The front formation surface 102 and the rear formation surface 103 may have the fixing portion 110 formed thereon. Specifically, the fixing portions 110 may be formed on an inner surface of the front formation surface 102 and an inner surface of the rear formation surface 103. However, it is not necessary for the fixing portion 110 to be formed on both the front formation surface 102 and the rear formation surface 103. The fixing portion 110 may be formed only on the front formation surface 102, only on the rear formation surface 103, or on both the front formation surface 102 and the rear formation surface 103. In other words, the fixing portion 110 may be formed on at least one of the front formation surface 102 and the rear formation surface 103.

The display panel 10 may be seated on the outer surface of the front formation surface 102, as described above. The light guide plate 90 of the BLU 20 may contact the outer surface of the rear formation surface 103 to support and hold the light guide plate 90.

The front formation surface 102 and the rear formation surface 103 may be formed parallel to facilitate insertion of the plurality of optical sheets 50 and support the display panel 10 and the light guide plate 90. However, the present disclosure is not limited thereto.

The sheet holder 100 may include an opening 110a formed on one side for inserting the plurality of optical sheets 50 in one direction. The plurality of optical sheets 50 may be inserted into the sheet holder 100 through the opening 110a. The opening 110a may be formed in a position opposite to the outer edge 101. In other words, the opening 110a may be formed such that the sheet holder 100 may hold the edge of the plurality of optical sheets 50.

Since the plurality of optical sheets 50 may be secured by simply inserting them into the sheet holder 100, there is no need for separate sheet holding grooves to be formed in the plurality of optical sheets 50. In the event that the sheet holding grooves are formed in the plurality of optical sheets 50, glare (e.g., light leakage, light flare, etc.) may occur, which may reduce the display quality of the display apparatus 1. In addition, since a blanking process for forming separate sheet holding grooves is not required, the manufacturing process may be simplified and costs may be reduced. Furthermore, since hooks or support protrusions for supporting the plurality of optical sheets 50 do not need to be formed on the middle mold 60, manufacturing may be facilitated.

The sheet holder 100 may include an insertion space S formed by the outer edge 101, the front formation surface 102, and the rear formation surface 103. The plurality of optical sheets 50 may be inserted and positioned in the insertion space S. Since the plurality of optical sheets 50 is required to be inserted in the insertion space S, it may have a spacing larger than the thickness of the plurality of optical sheets 50.

The sheet holder 100 may include the fixing portion 110 protruding from the sheet holder 100 to hold the plurality of optical sheets 50. The fixing portion 110 may protrude through the insertion space S. In other words, the fixing portion 110 may protrude toward the inner side of the sheet holder 100.

The fixing portion 110 may be formed to be inclined in one direction such that the plurality of optical sheets 50 may be inserted in one direction. In other words, the fixing portion 110 may be formed to be inclined in one direction toward an end of the fixing portion 110. When the fixing portion 110 is inclined in a direction opposite to the insertion direction of the plurality of optical sheets 50, the plurality of optical sheets 50 cannot be inserted, so it is inclined in the same direction as the insertion direction.

The fixing portion 110 may be injection molded together with the sheet holder 100. As described above, the sheet holder 100 may be injection molded together with the middle mold 60, and the fixing portion 110 may also be injection molded together.

The fixing portion 110 may include an elastic material. For example, the fixing portion 110 may be formed of a plastic material or a metallic material. The fixing portion 110 needs to be elastically deformable as the plurality of optical sheets 50 are inserted, so that the plurality of optical sheets 50 may be inserted without damage.

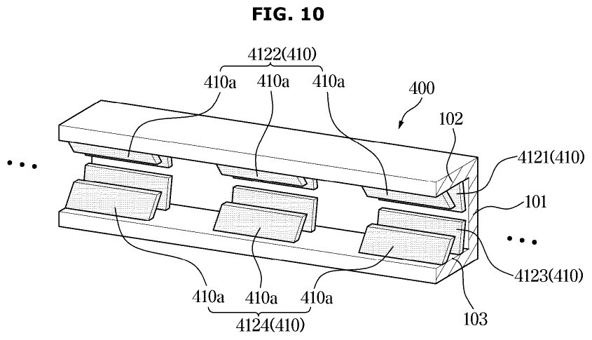

The fixing portion 110 may extend along a longitudinal direction of the sheet holder 100. The plurality of optical sheets 50 may have a size similar to at least the display panel 10, and thus one edge thereof may have a somewhat long length. To securely fix the one edge of the plurality of optical sheets 50, the fixing portion 110 may be configured to extend over at least the one edge of the plurality of optical sheets 50. However, the present disclosure is not limited thereto, and as shown in FIG. 10, which will be described later, the fixing portion 110 may also be formed to include a plurality of fixing members.

In FIGS. 6A and 6B, the plurality of optical sheets 50 are shown as consisting of three sheets. However, the present disclosure is not limited thereto, and may include a greater number of sheets, and each sheet may be provided with a different thickness.

The fixing portion 110 may include first fixing portions 1101 and 1103 located further away, i.e., more inward, from the opening 110a of the sheet holder 100, and second fixing portions 1102 and 1104 located closer to the opening 110a of the sheet holder 100. In other words, the second fixing portions 1102 and 1104 may protrude at positions spaced apart from the first fixing portions 1101 and 1103 along a direction opposite to the one direction, which is the insertion direction of the plurality of optical sheets 50.

The second fixing portions 1102 and 1104 may be formed with a shorter protruding length than the first fixing portions 1101 and 1103. When the protruding length of the second fixing portions 1102 and 1104 is formed longer than or equal to that of the first fixing portions 1101 and 1103, it may be difficult for the first fixing portions 1101 and 1103 to function to hold one of the plurality of optical sheets 50. Therefore, the second fixing portions 1102 and 1104 may be formed with a shorter protruding length than the first fixing portions 1101 and 1103.

The second fixing portions 1102 and 1104 may be provided with a larger degree of inclination than the first fixing portions 1101 and 1103. As shown in FIG. 6A, based on the first fixing portions 1101 and 1103 and the second fixing portions 1102 and 1104 protruding from the front formation surface 102, an angle between the second fixing portions 1102 and 1104 and the front formation surface 102 may be smaller than an angle between the first fixing portions 1101 and 1103 and the front formation surface 120.

The larger the degree of inclination of the fixing portion 110, the smaller the fixing force may be. In other words, since the amount of deformation as the plurality of optical sheets 50 are inserted is small, the fixing force may become weaker. Accordingly, the first fixing portions 1101 and 1103 and the second fixing portions 1102 and 1104 may need to be formed to be inclined at a certain level. However, in case the degree of inclination of the first fixing portion 1101 is larger than the degree of inclination of the second fixing portion 1102, the fixing efficiency may decrease.

Since the first fixing portion 1101 is provided with a longer protruding length than the second fixing portion 1102, the degree to which it may be deformed may be large. Accordingly, the first fixing portion 1101 may need to be formed with a small degree of inclination along one direction, so that it may exert a strong elastic force due to more deformation when the plurality of optical sheets 50 are inserted.

On the other hand, since the second fixing portion 1102 is provided with a shorter protruding length than the first fixing portion 1101, the degree to which it may be deformed may be small. Therefore, the second fixing portion 1102 may be formed with a larger degree of inclination than the first fixing portion 1101. This is because the second fixing portion 1102 has a short protruding length and thus a small degree of deformation, i.e., less elastic force may be stored. When the second fixing portion 1102 has a small degree of inclination, the second fixing portion 1102 may not be able to withstand the deformation caused by the plurality of optical sheets 50 and may be damaged.

Similarly, as shown in FIG. 6B, even when the first fixing portion 1103 and the second fixing portion 1104 protrude from the rear formation surface 103, an angle between the second fixing portion 1104 and the rear formation surface 103 may be smaller than an angle between the first fixing portion 1103 and the rear formation surface 103.

On the other hand, each of the first fixing portions 1101 and 1103 and the second fixing portions 1102 and 1104 may not necessarily be capable of fixing only one sheet constituting the plurality of optical sheets 50. In other words, as shown in FIG. 6A, the first fixing portion 1101 may fix two optical sheets 50B and 50C, and as shown in FIG. 6B, the first fixing portion 1103 may fix two optical sheets 50A and 50B. However, the present disclosure is not limited thereto, and the plurality of optical sheets 50 may be configured to include a larger number of optical sheets. Accordingly, the first fixing portions 1101 and 1103 may also fix a larger number of optical sheets, and the second fixing portions 1102 and 1104 may also fix a larger number of optical sheets.

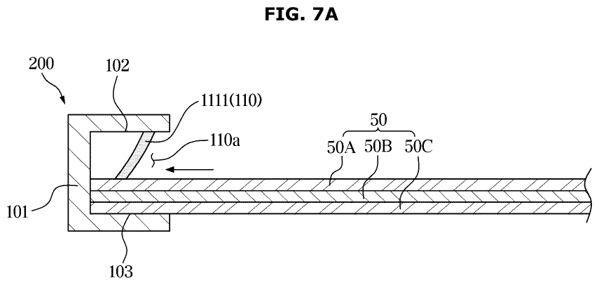

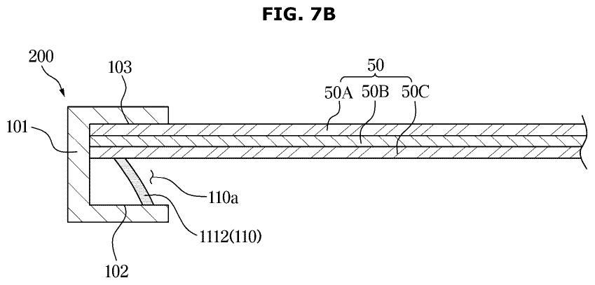

FIGS. 7A and 7B are views illustrating a state in which the plurality of optical sheets are coupled to the sheet holder according to one or more embodiments.

Referring to FIGS. 7A and 7B, the sheet holder 200 may include a front fixing portion 1111 protruding from the front formation surface 102, or may include a rear fixing portion 1112 protruding from the rear formation surface 103. The front fixing portion 1111 and the rear fixing portion 1112 may be formed at positions corresponding to each other. In other words, the front fixing portion 1111 and the rear fixing portion 1112 may be located at the same distance from the outer edge 101 or the opening 110a. The front fixing portion 1111 and the rear fixing portion 1112 may be provided together, or, only the front fixing portion 1111 may be provided, or only the rear fixing portion 1112 may be provided.

As shown in FIG. 7A, the front fixing portion 1111 may fix the plurality of optical sheets 50 at once. Similarly, the rear fixing portion 1112 of FIG. 7B may also fix the plurality of optical sheets 50 at once. When the front fixing portion 1111 and the rear fixing portion 1112 are each configured as one, any number of the plurality of optical sheets 50 may be fixed. Accordingly, the manufacturing of the sheet holder 200, the front fixing portion 1111, and the rear fixing portion 1112 may be facilitated. However, in this case, depending on the thickness of the plurality of optical sheets 50, the protruding length and rigidity of the front fixing portion 1111 and the rear fixing portion 1112 may need to be properly considered.

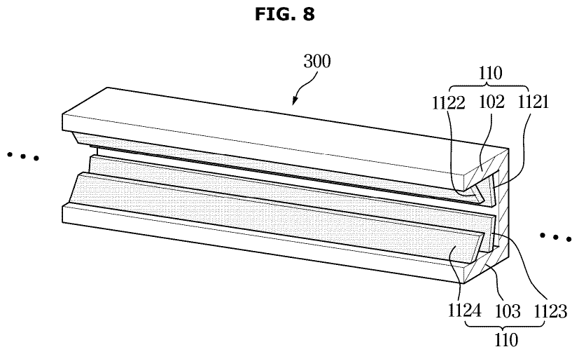

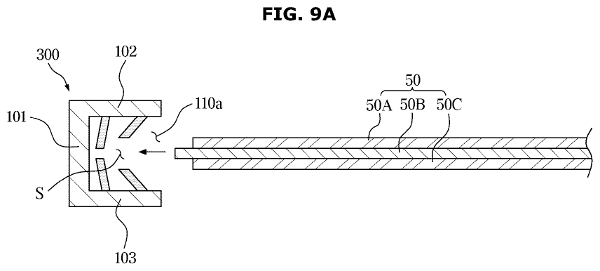

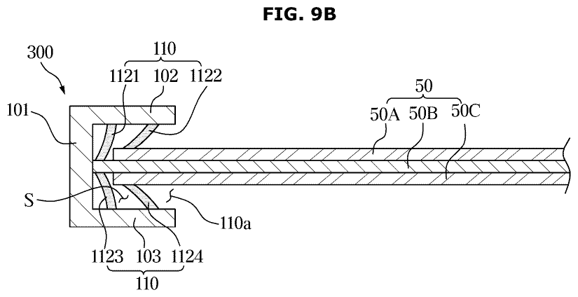

FIG. 8 is a view illustrating a structure of a sheet holder according to one or more embodiments. FIGS. 9A and 9B are side views illustrating a process in which the plurality of optical sheets are fixed to the sheet holder of FIG. 8.

Referring to FIGS. 8, 9A, and 9B, the sheet holder 300 may include a front fixing portion 1121 protruding from the front formation surface 102 and a rear fixing portion 1123 protruding from the rear formation surface 103. As shown in FIG. 7A and 7B, the front fixing portion 1121 and the rear fixing portion 1123 may be formed at positions corresponding to each other.

The fixing portion 110 may include a first front fixing portion 1121 and a second front fixing portion 1122 protruding at a position spaced apart from the first front fixing portion 1121 along another direction. The second front fixing portion 1122 may be located closer to the opening 110a than the first front fixing portion 1121.

The fixing portion 110may include a first rear fixing portion 1123 and a second rear fixing portion 1124 protruding at a position spaced apart from the first rear fixing portion 1123 along another direction. The second rear fixing portion 1124 may be located closer to the opening 110a than the first rear fixing portion 1123.

As described above in FIGS. 5A, 5B, 6A and 6B, the second front fixing portion 1122 and the second rear fixing portion 1124 may be formed with the a shorter protruding length than the first front fixing portion 1121 and the first rear fixing portion 1123. In other words, the first fixing portion 1101 and the second fixing portion 1102 shown in FIGS. 5A, 5B, 6A, and 6B may be arranged symmetrically along the front-to-back direction.

However, the present disclosure is not limited thereto, and the front fixing portions 1121 and 1122 and the rear fixing portions 1123 and 1124 may be provided in different numbers. For example, the front fixing portions 1121 and 1122 may be provided in three, and the rear fixing portions 1123 and 1124 may be provided in two. In this case two of each of the front fixing portions 1121 and 1122 and the rear fixing portions 1123 and 1124 may be provided at corresponding positions.

In addition, the second front fixing portion 1122 and the second rear fixing portion 1124 may be formed with a larger degree of inclination along one direction than the first front fixing portion 1121 and the first rear fixing portion 1123. In other words, an angle that the first front fixing portion 1121 and the first rear fixing portion 1123 form with the front formation surface 102 and the rear formation surface 103 may be formed to be larger than an angle that the second front fixing portion 1122 and the second rear fixing portion 1124 form with the front formation surface 102 and the rear formation surface 103.

The plurality of optical sheets 50 may be configured with a plurality of sheets having different thicknesses, such that each sheet may be fixed by a different fixing portion 110. As shown herein, by providing two fixing portions each at the front and rear, each of the three optical sheets 50A, 50B and 50C may be supported and thus effectively fixed.

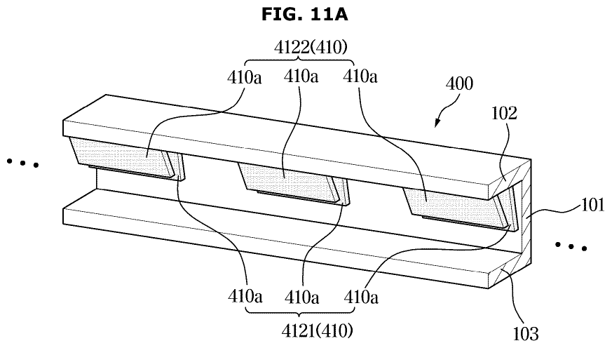

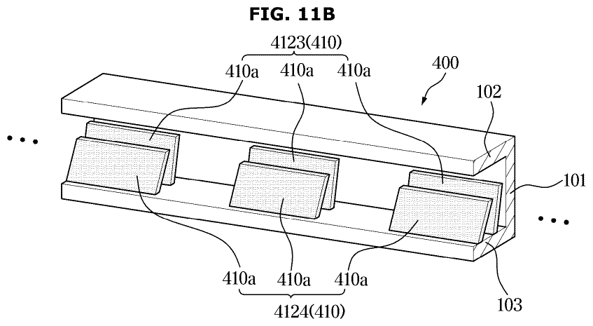

FIG. 10 is a view illustrating a state in which the fixing portion configured with a plurality of fixing members is provided on both the front and rear formation surfaces of a sheet holder, according to one or more embodiments. FIGS. 11A and 11B are vies illustrating a state in which the fixing portion configured with the plurality of fixing members is provided on the front or rear formation surface of a sheet holder, according to one or more embodiments.

Referring to FIGS. 10 and 11, the sheet holder 400 may include a fixing portion 410 formed to be spaced apart along the longitudinal direction of the sheet holder 400. The fixing portion 410 may include a plurality of fixing members 410a having a predetermined length and arranged to be spaced apart along the longitudinal direction of the sheet holder 400.

The plurality of fixing members 410a may be arranged over the entire area of the sheet holder 400. In other words, the plurality of fixing members 410a may have the same effect as the fixing portion 410 extending along the longitudinal direction of the sheet holder 400, while saving material used for manufacturing. Furthermore, each of the plurality of fixing members 410a may be deformed when the plurality of optical sheets 50 are inserted, so that the insertion of the plurality of optical sheets 50 may be facilitated.

In this case, as shown in FIGS. 11A and 11B, the fixing portion 410 may be formed on at least one of the front formation surface 102 and the rear formation surface 103. Furthermore, the fixing portion 410 may include first front fixing portions 4121, second front fixing portions 4122 formed on the front formation surface 102, and first rear fixing portions 4123, second rear fixing portions 4124 formed on the rear formation surface 103.

The fixing portion 410 may not be configured as the plurality of fixing members 410a, but may be formed by cutting out parts at predetermined intervals while the fixing portion 410 extends along the longitudinal direction of the sheet holder 400. In other words, the fixing portion 410 may be formed in the shape of an approximately square sawtooth. In this case, as the plurality of optical sheets 50 are inserted, the area of the end of the fixing portion 410 that undergoes substantial deformation may become smaller, thereby facilitating deformation.

The display apparatus 1 according to one or more embodiments may include the display panel 10, the BLU 20 supplying light to the display panel 10 and comprising the plurality of optical sheets 50, the bottom chassis 76 disposed behind the BLU 20, and the middle mold 60 seated on the bottom chassis. The middle mold may include the sheet holder, such as any of sheet holder 100, sheet holder 200, sheet holder 300 or sheet holder 400, provided on one edge of the middle mold, the sheet holder including the opening 110a formed on one side thereof to allow the plurality of optical sheets to be inserted in one direction. The middle mold may include the fixing portion 110 or the fixing portion 410 protruding from the sheet holder to fix the plurality of optical sheets, the fixing portion being inclined in the one direction toward an end thereof. According to the spirit of the present disclosure, the display quality of the display apparatus may be improved. According to the spirit of the present disclosure, the manufacturing of the optical sheet included in the display apparatus may be facilitated. According to the spirit of the present disclosure, since the sheet holding grooves are not formed on the optical sheet, glare may be prevented. According to the spirit of the present disclosure, the optical sheet may be held without forming sheet holding grooves.

The fixing portion 110 may extend along the longitudinal direction of the sheet holder. According to the present disclosure, the fixing portion 110 may support the entire one edge of the plurality of optical sheets 50, thereby providing structural stability.

The fixing portion 410 may include the plurality of fixing members 410a formed spaced apart along the longitudinal direction of the sheet holder. According to the present disclosure, a material used for manufacturing the fixing portion 410 may be saved, and since each of the plurality of fixing members 410a is deformed when the plurality of optical sheets 50 are inserted, the insertion of the plurality of optical sheets 50 may be facilitated.

The fixing portion may be a first fixing portion 1101, and the middle mold 60 may further include a second fixing portion 1102 protruding at a position spaced apart from the first fixing portion along another direction, the second fixing portion having a shorter protruding length than the first fixing portion. According to the present disclosure, the plurality of optical sheets 50 having different thicknesses may be effectively fixed.

The second fixing portion 1102 may be provided with a larger degree of inclination than the first fixing portion 1101. According to the present disclosure, the fixing force of the fixing portion may be effectively exerted.

The sheet holder may include the outer edge 101 forming the other side of the sheet holder. The sheet holder may include the front formation surface 102 and the rear formation surface 103 extending from the outer edge to face each other. The outer edge 101, the front formation surface 102, and the rear formation surface 103 may form the insertion space S to allow the plurality of optical sheets to be inserted through the opening 110a.

The fixing portion 110 may be formed on at least one of the front formation surface 102 and the rear formation surface 103.

The fixing portion may include the front fixing portion 1111 protruding from the front formation surface and the rear fixing portion 1112 protruding from the rear formation surface. The front fixing portion 1111 and the rear fixing portion 1112 may be formed at positions corresponding to each other.

The front fixing portion may be the first front fixing portion 1121, and the fixing portion may further include the second front fixing portion 1122 protruding at a position spaced apart along another direction, the second front fixing portion having a shorter protruding length than the first front fixing portion 1121. According to the present disclosure, the plurality of optical sheets 50 having different thicknesses may be effectively fixed.

The rear fixing portion may be the first rear fixing portion 1123, and the fixing portion may further include the second rear fixing portion 1124 protruding at a position spaced apart along another direction, the second rear fixing portion having a shorter protruding length than the first rear fixing portion 1123. According to the present disclosure, the plurality of optical sheets 50 having different thicknesses may be effectively fixed.

The second front fixing portion 1122 may be provided with a larger degree of inclination than the first front fixing portion 1121. According to the present disclosure, the fixing force of the fixing portion may be effectively exerted.

The second rear fixing portion 1124 may be provided with a larger degree of inclination than the first rear fixing portion 1123. According to the present disclosure, the fixing force of the fixing portion may be effectively exerted.

The plurality of optical sheets 50 may each have different thicknesses.

The sheet holder, such as any of sheet holder 100, sheet holder 200, sheet holder 300 or sheet holder 400, may be formed on the upper edge 61 of the middle mold. According to the present disclosure, the optical sheets may be effectively fixed by providing a minimum number of sheet holders.

The fixing portion may include an elastically deformable material. According to the present disclosure, the plurality of optical sheets may be inserted without damage.

A display apparatus according to one or more embodiments includes the display panel 10, the BLU 20 disposed behind the display panel and including the plurality of optical sheets 50, the bottom chassis 76 accommodating the BLU, and the middle mold 60 coupled to the bottom chassis and supporting the plurality of optical sheets. The middle mold 60 may include the sheet holder, such as any of sheet holder 100, sheet holder 200, sheet holder 300 or sheet holder 400, extending along one edge of the middle mold, the sheet holder including the insertion space S to allow the plurality of optical sheets to be inserted in one direction. The middle mold may include the fixing portion 110 or 410 protruding into the insertion space to fix the plurality of optical sheets, the fixing portion being inclined in one direction toward an end thereof.

The fixing portion may extend along the longitudinal direction of the sheet holder.

The fixing portion may be the first fixing portions 1101 and 1103, and the middle mold may further include the second fixing portions 1102 and 1104 protruding at a position spaced apart from the first fixing portion along another direction, the second fixing portion having a shorter protruding length than the first fixing portion.

A display apparatus according to one or more embodiments may include the BLU 20 disposed behind an display panel and including the plurality of optical sheets 50, the bottom chassis 76 accommodating the BLU, and the middle mold 60 coupled to the bottom chassis and supporting the plurality of optical sheets. The middle mold 60 may include the sheet holder, such as any of sheet holder 100, sheet holder 200, sheet holder 300 or sheet holder 400, extending along one edge of the middle mold, the sheet holder including the opening 110a and the insertion space S to allow the plurality of optical sheets to be inserted in one direction. The middle mold may include the plurality of fixing portions, i.e., the first front fixing portion 1121, the second front fixing portion 1122, the first rear fixing portion 1123, and the second rear fixing portion 1124, protruding into the insertion space to fix the plurality of optical sheets. The plurality of fixing portions may be inclined in one direction toward ends thereof and arranged spaced apart along one direction.

The sheet holder may include the outer edge 101 forming the other side of the sheet holder. The sheet holder may include the front formation surface 102 and the rear formation surface 103 extending from the outer edge to face each other. The plurality of fixing portions, i.e., the first front fixing portion 1121, the second front fixing portion 1122, the first rear fixing portion 1123, and the second rear fixing portion 1124, may protrude from the front formation surface 102 and the rear formation surface 103 and be formed at corresponding positions.

According to the spirit of the present disclosure, the display quality of the display apparatus may be improved.

According to the spirit of the present disclosure, the manufacturing of the optical sheet included in the display apparatus may be facilitated.

According to the spirit of the present disclosure, since sheet holding grooves are not formed on the optical sheet, glare may be prevented.

According to the spirit of the present disclosure, the optical sheet may be fixed without forming sheet holding grooves.

The effects to be obtained from the present disclosure are not limited to those mentioned above, and other effects not mentioned will be apparent to a person skilled in the art to which the present disclosure belongs from the following description.

Although specific embodiments have been illustrated and described above, the present disclosure is not limited to the embodiments described above, and it will be apparent to those skilled in the art that various changes and modifications can be made without departing from the gist of the technical spirit of the disclosure described in the claims below.

What is claimed is:

1. A display apparatus comprising:
a display panel;
a backlight unit configured to supply light to the display panel and comprising a plurality of optical sheets;
a bottom chassis behind the backlight unit; and
a middle mold on the bottom chassis;
wherein the middle mold comprises:
a sheet holder on one edge of the middle mold, the sheet holder comprising an opening through which the plurality of optical sheets are inserted in one direction, and
a fixing portion protruding from the sheet holder and configured to fix the plurality of optical sheets, the fixing portion being at least partly inclined in the one direction.

2. The display apparatus of claim 1, wherein the fixing portion extends along a longitudinal direction of the sheet holder.

3. The display apparatus of claim 1, wherein the fixing portion comprises a plurality of fixing members that are spaced apart along a longitudinal direction of the sheet holder.

4. The display apparatus of claim 2, wherein the fixing portion comprises a first fixing portion, and
wherein the middle mold further comprises a second fixing portion protruding at a position spaced apart from the first fixing portion along another direction, the second fixing portion having a shorter protruding length than the first fixing portion.

5. The display apparatus of claim 4, wherein the second fixing portion has a degree of inclination that is greater than a degree of inclination of the first fixing portion.

6. The display apparatus of claim 1, wherein the sheet holder further comprises:
an outer edge forming the one side of the sheet holder,
a front formation surface extended from the outer edge; and
a rear formation surface, extended from the outer edge and facing the front formation surface, and
wherein the outer edge, the front formation surface, and the rear formation surface define an insertion space into which the plurality of optical sheets are inserted through the opening.

7. The display apparatus of claim 6, wherein the fixing portion is on at least one of the front formation surface and the rear formation surface.

8. The display apparatus of claim 7, wherein the fixing portion comprises a first front fixing portion protruding from the front formation surface, and a first rear fixing portion protruding from the rear formation surface, and
wherein the first front fixing portion and the first rear fixing portion are at positions corresponding to each other.

9. The display apparatus of claim 8, wherein the fixing portion further comprises a second front fixing portion protruding at a position spaced apart along another direction, the second front fixing portion having a protruding length that is less than a protruding length of the first front fixing portion.

10. The display apparatus of claim 8, wherein the fixing portion further comprises a second rear fixing portion protruding at a position spaced apart along another direction, the second rear fixing portion having a protruding length that is less than a protruding length of the first rear fixing portion.

11. The display apparatus of claim 9, wherein the second front fixing portion has a degree of inclination that is greater than a degree of inclination of the first front fixing portion.

12. The display apparatus of claim 10, wherein the second rear fixing portion has a degree of inclination that is greater than a degree of inclination of the first rear fixing portion.

13. The display apparatus of claim 1, wherein the plurality of optical sheets comprise a first optical sheet and a second optical sheet, and a thickness of the first optical sheet is different than a thickness of the second optical sheet.

14. The display apparatus of claim 1, wherein the sheet holder is on an upper edge of the middle mold.

15. The display apparatus of claim 1, wherein the fixing portion comprises an elastically deformable material.
